(19) United States
(12) Patent Application Publication
(10) Pub. No.: US 2007/0157087 A1
(43) Pub. Date: Jul. 5, 2007

(54) Method and system for automatically generating user interfaces for integration

(76) Inventors: Karl-Heinz Foerg, Schriesheim (DE); Heinz Pauly, Ludwigshafen (DE); Winald Kasch, Hamburg (DE)

Correspondence Address: KENYON & KENYON LLP, 1500 K STREET N.W., WASHINGTON, DC, 20005, US

(21) Appl. No.: 11/320,630

(22) Filed: Dec. 30, 2005

(51) Int. Cl. G06F 3/00

(52) U.S. Cl. 715/700

(57) ABSTRACT

Embodiments of the present invention relate to automating the creation of user interfaces for integration. Integration is a process that involves accounting for the differences between two different types of software to enable the exchange of information between the two types of software. Typically, the initial work of the integration process produces a useful storehouse of information about message formats, mappings, data manipulations and other information related to integration. Further on, the deployment of a concrete integration solution adds data about a specific integration landscape to this storehouse. Embodiments of the present invention relate to processing information in this storehouse to automatically generate user interfaces for use in performing integration control operations.

### BACKGROUND OF THE INVENTION

Different software applications may need to exchange data. For example, a computer system running mySAP ERP® business software may need to exchange customer information, purchase and sales order information, or other information, with a different computer system running, say, Oracle® business software.

The two types of business software may differ in various ways. For example, they may differ in the message formats that they read and write, the file formats that they store data in, the data access methods that they use, the types of connectivity middleware that they are compatible with, and the like. To enable the exchange of information between the two types of software, these differences must be accounted for. The process of accounting for the differences may be referred to as “integration.”

Integration may involve, for example, mapping. Mapping involves, for example, identifying differences and similarities in software data structures, keys, values and behaviors, and building bridges or translations between these elements, so that software can communicate. Examples of mapping include key mapping and value mapping. Key mapping involves assigning correspondences between respective data keys used by two different business applications (e.g., “data key X for business application 1 is equivalent to data key Y for business application 2”), so that one application can understand what another application's key means. Similarly, value mapping involves assigning correspondences between respective data values used by two different business applications (e.g., “values {1, 2, 3 . . . } for business application 1 are equivalent to values {a, b, c, . . . } for business application 2”) so that the applications can understand each other.

Integration may further include manipulating data messages of two different systems based on an understanding of what the messages contain. For example, a programmer, to integrate two systems, might write code to create a new message usable by one of the systems based on data in a message or multiple messages of the other system. The code might, say, extract two fields from a source message emitted by one system, store the extracted fields in a field of a new output message, define initial values in fields of the output message, and the like, in order to make the output message suitable for use by the other system. Integration might, therefore, include copying, deleting, inserting or modifying messages or portions of messages, typically for the purpose of facilitating the exchange of information between different systems. The message types involved in such operations may be customer-specific. Accordingly, in the integration process, the programmer typically comes to have an expert knowledge of the message types and of the integration logic. The programmer therefore can produce code to directly manipulate the messages and thus, further, associated databases.

Once developed, an integration solution needs to be adjusted and controlled. That is, while there may an initial period when expert consultants develop an integration solution and deploy it on a computer system, it is typically the case that maintenance and daily operation must be performed. Usually, the consultants have moved on to another project and the maintenance tasks must be performed by end users, who typically do not have the expert knowledge of the consultants. Therefore, often as part of an initial deployment, expert consultants will develop user interfaces that enable an end user to perform required maintenance tasks. The maintenance tasks may involve making needed adjustments to the original integration solution. For example, an end user may need the capability to change message headers or other message properties on demand. Such a customizing capability may be provided by way of a maintenance user interface whereby an end user is able to make desired adjustments. That is, the user interface guides the user. The user need only, for example, respond to a series of prompts. In response to information entered by the user, underlying functionality coded by an expert performs the operations, such as the direct manipulation of data on a database, that are actually needed.

Administrative tasks of daily operation also involve user interfaces. Examples of typical administrative tasks include the daily monitoring of the overall integration system and monitoring/correcting exceptional operation conditions (e.g. exhausted table space in databases, non-delivered messages and so on).

Creating such a customized maintenance or administrative user interface manually (e.g., developing the corresponding screen displays and coding the underlying functionality) is typically a laborious, time-consuming and error-prone process. Often, creating the user interface takes considerably more time than providing the integration functionality itself. However, the capabilities of such user interfaces must be provided to an end user because the end user typically does not have the technical knowledge to control/monitor/customize/administer the associated integration operations directly.

### BRIEF DESCRIPTION OF THE DRAWINGS

FIG. 1 shows a system according to embodiments of the present invention;

FIG. 2 shows further details of the system of FIG. 1;

FIG. 3 shows details of generator functionality according to embodiments of the present invention;

FIG. 4 shows a process flow according to embodiments of the present invention; and

FIG. 5 shows a computer system for implementing embodiments of the present invention.

### DETAILED DESCRIPTION

In view of the above, embodiments of the present invention relate to automating the creation of user interfaces for integration. The user interfaces may be automatically generated based on integration metadata. The integration metadata may comprise information and functionality relating to the integration of two or more systems. The integration metadata may be automatically processed to generate the user interfaces. By automating the creation of user interfaces in this way, the laborious, time-consuming and error-prone effort of creating the user interfaces manually is avoided.

Once generated, the user interfaces may comprise one or more displays and background functionality. The displays or “front-end” of the user interfaces may, for example, guide a user through setting up an integration control operation that manipulates the behavior of the basic integration logic. Once performed, a control operation may, for example, change how messages are manipulated for purposes of inter-system communication. Thus, a control operation may change message mappings, content or appearance of messages or portions of messages, message properties, or other features. The background functionality of the user interface may process information entered by the user to set up the control operation, while the user need only respond to prompts from the front-end.

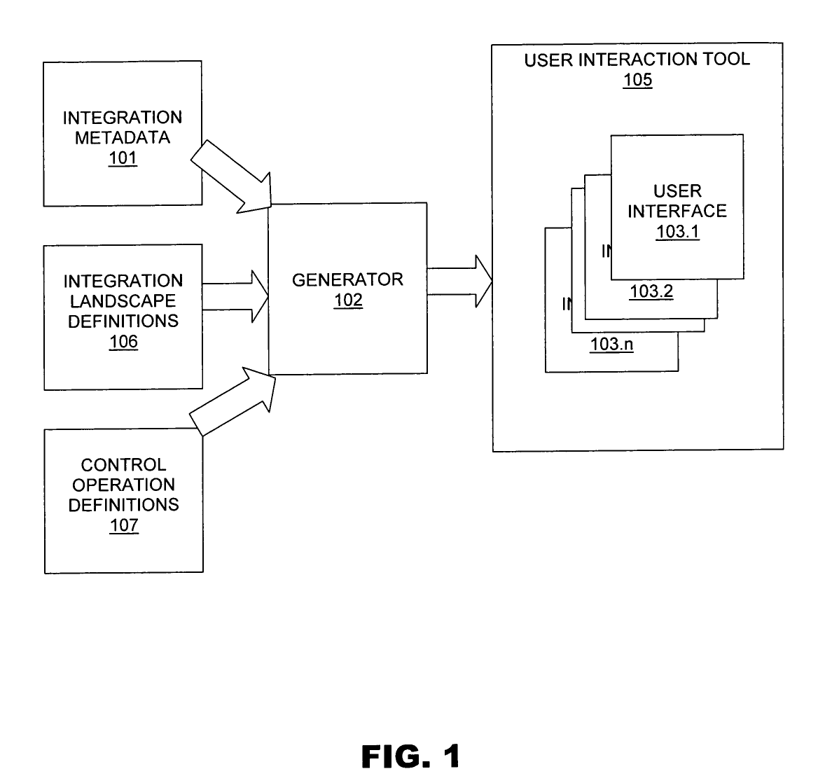

FIG. 1 shows a system according to embodiments of the present invention. The system may comprise integration metadata 101, integration landscape definitions 106 and control operation definitions 107, each of which may be stored electronically as data on a machine-readable medium such as disk. A generator 102 may process the metadata 101, landscape definitions 106 and control operation definitions 107 to generate, on-the-fly, a plurality of user interfaces 103.1, 2, . . . n. (As is known, in relation to computer technology, “on the fly” describes activities that develop or occur dynamically rather than as the result of something that is statically predefined. For example, the content of a page that is sent from a Web site can be developed and varied “on the fly” based on dynamic factors such as the time of day, what pages the user has looked at previously, and specific user input.) A user interface may include one or more screen displays and underlying or background functionality to control display appearance, navigate through the displays, and process information to set up a control operation.

The integration metadata 101 may, for example, be collected over the course of doing the original work of integration. That is, as noted earlier, there may be an initial development phase for integration. This initial development phase may include defining/importing message types, doing all the necessary mapping, and developing functionality for performing the necessary manipulation of data. Thus, the original work, while creating a basic integration solution for deployment, also produces a useful storehouse of functionality and information relating to data manipulation, message formats, mappings and other information related to integration.

The integration landscape definitions 106 may be collected, for example, when deploying a concrete integration solution at a customer site, and may include connectivity information for the systems involved in the operation of the solution. The connectivity information, more specifically, may relate to connectivity protocols that will work to connect different systems, protocols such as HTTP (Hypertext Transfer Protocol), Open Database Connectivity (OBDC) or lava Database Connectivity (JDBC).

The control operation definitions 107 may include an identification of one or more control operations that are or may need to be performed on an ongoing basis, for example to perform maintenance after an initial integration project is completed. An example of a control operation is customizing a message, such as changing a message header to be customer-specific. Another example of a control operation is changing a zip code range that acts as a filter for messages. The foregoing (i.e., a message header and a message filter) are examples of control data that may be changed by a control operation. As used herein, “control data” means data that controls how messages look or are manipulated for purposes of inter-system communication. A control operation that changes control data may therefore change message mappings, content or appearance of messages or portions of messages, message properties, or other features.

The generator 102 may match information in the metadata 101 relating to message formats, mappings, data manipulations and so on with a given control operation definition in the definitions 107, taking into account the concrete integration landscape as defined in the landscape definitions 106, and build a user interface via which a user can set up the control operation to manipulate the behavior of a deployed integration solution.

The interfaces may be generated on-the-fly by the generator 102. The generator 102 may then hand over control to a user interaction tool 105 which enables a user to select an appropriate user interface 103.i. Via the selected user interface, the user can control the behavior of the integration solution without needing to go down to database level and actually manipulate control data directly. Instead, the user can simply navigate through the user interface, respond to prompts and enter information. The background functionality of the user interface may process the responses of the user to set up a control operation that can manipulate control data. The control data, in turn, controls the behavior of the integration solution (i.e., for example, the appearance of messages, how messages are mapped, how messages are manipulated for inter-system communication, and so on).

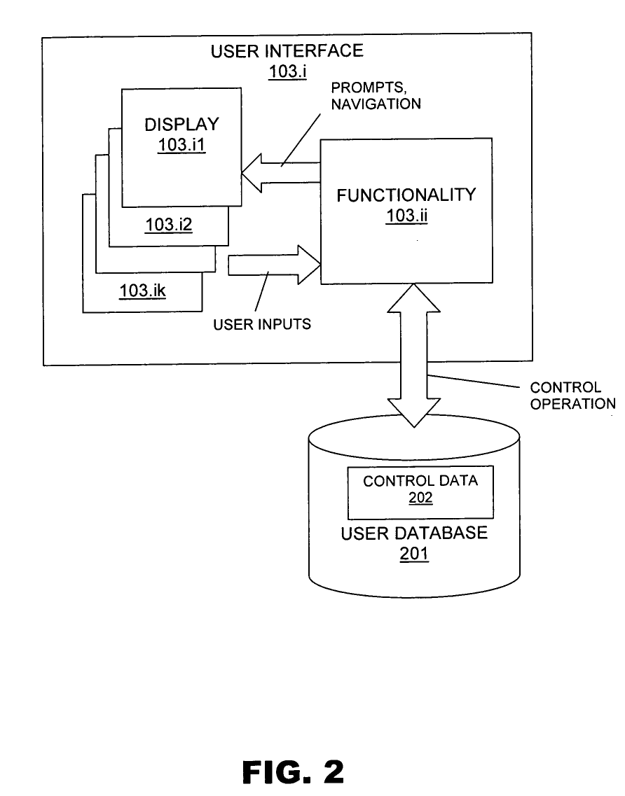

FIG. 2 illustrates embodiments of the invention in more detail. As noted earlier, a user interface 103.i generated by generator 102 may comprise a plurality of displays 103.i1, i2, . . . , ik, and background functionality 103.ii. The displays 103.i1, i2, . . . , ik may present a user with input and output fields having a format determined by the generator 102. Capabilities of the background functionality 103.ii may include: saving information initially entered in the displays 103.i1, i2, . . . , ik by a user; reading stored information and displaying it in the displays 103.i1, i2, . . . , ik in a suitable way; enabling the alteration of previously stored information in a suitable way; and enabling the deletion of information. Functionality 103.ii may further control navigation of the displays and issue prompts for user inputs. The functionality 103.ii may process the user inputs to set up a corresponding control operation to change control data 202 on a user database 201.

The functionality 103.ii and displays may further, for example, enable a user to link to various different systems that need to be integrated, retrieve data from the various systems, process the data and store the processed data on the various systems.

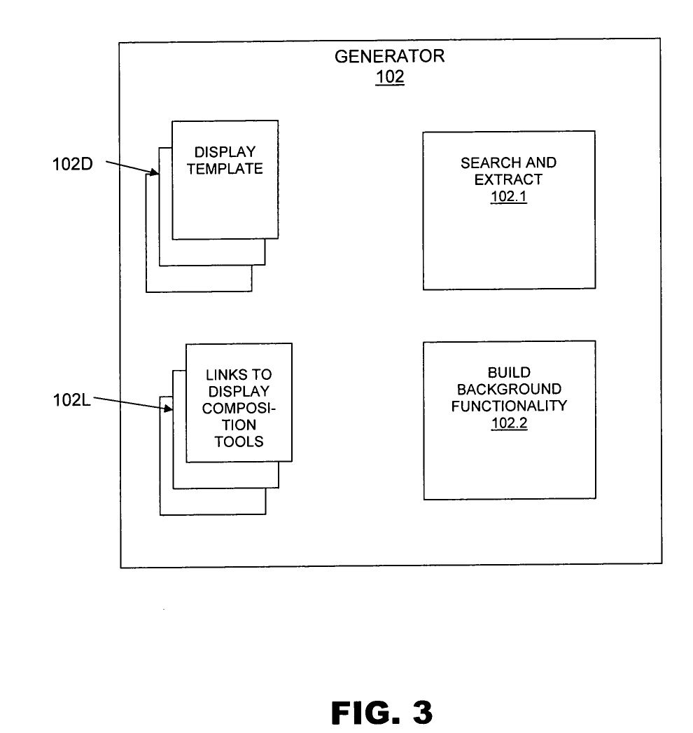

FIG. 3 shows the generator 102 in more detail. The generator 102 may be implemented as computer-executable instructions stored on a machine-readable medium such as disk. As noted, the user interaction tool 105 may comprise screen displays as part of user interfaces 103.1, . . . , n. Accordingly, to create these displays, generator 102 may comprise a plurality of display templates 102D which are adaptable to various message formats and control operations. Additionally or alternatively, generator 102 may include links 102L to display composition tools able to arrange or “paint” screen layouts in a user-defined way according to a format determined by the generator and the control operation to be performed. This format may supersede an automatically generated default layout. For example, the generator 102 could call a known display composition tool such as a tool based on SAP's Visual_Composer or Microsoft's Screen painters of Visual Studio, and pass the display composition tool parameters to control the tool so as to produce a display with the desired appearance and input/output fields.

The generator 102 may further include search and extract logic 102.1. Based on the control operation definitions 107, the search and extract logic 102.1 may search for and extract corresponding information from the integration metadata 101 and integration landscape definitions 106. For example, a given control operation may be, say, the operation “Change message header for Customer XYZ.” Based on this information, the generator 102 may search for corresponding information in the metadata 101, extract it and display it in a user interface 103.1, 2, . . . , n. The extracted information may include, for example, the format of customer messages for customer XYZ. The user may then alter the information as desired.

The search and extract logic may further choose which screens to present/display and how to arrange their access due to the given integration metadata 101 and to the given integration landscape definition 106. Thus, the search and extract logic may allow the integration tool 105 to automatically arrange the navigation among the generated user interfaces accordingly.

The generator 102 may further include logic 102.2 to build background functionality 103.ii of the user interfaces. As noted earlier, the background functionality 103.ii may operate to save information initially entered in the displays 103.i1, i2, . . . , ik by a user, read stored information and display it in the displays 103.i1, i2, . . . , ik, enable the alteration of previously stored information and enabling the deletion of information. Based on information received way of such operations, the background functionality 103.ii may set up a control operation. User interface navigation and prompting logic may also be built by logic 102.2 based on the operation that needs to be performed.

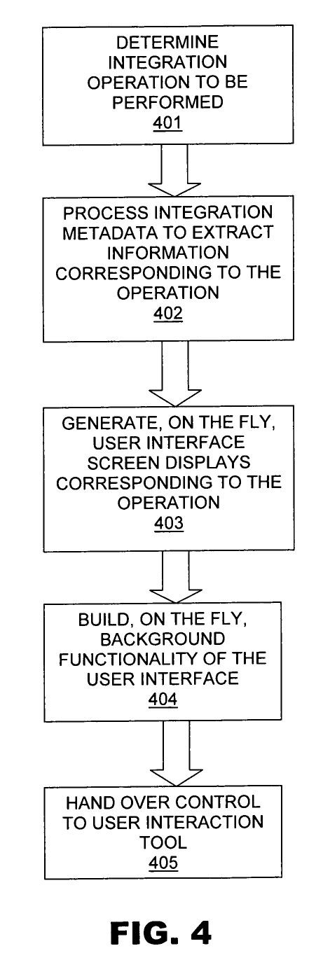

In view of the above, FIG. 4 shows a process flow according to embodiments of the present invention. As shown in block 401, it may be determined what control operation needs to be performed. The information as to what control operation needs to be performed may be supplied in the control operation definitions 107.

Based on the operation that needs to be performed, the generator 102 may process the integration metadata and/or the integration landscape definitions to extract corresponding information as shown in block 402.

As shown in block 403, the generator may generate, on-the-fly, user interface screen displays corresponding to the operation, using the extracted information. Further, the generator may build, on-the-fly, background functionality of the user interface using the extracted information, as shown in block 404. The generator may then hand over control to a user interaction tool, as shown in block 405.

Embodiments of the present invention may further relate to generating user interfaces that guide a user through an administrative operation, such as showing the state of progress for the overall processing of the integration solution and monitoring/correcting exceptional operation conditions. Showing the state of progress may include giving an overview of all currently ongoing and not-yet-completed/not-yet-begun jobs in order provide information as to how much of a workload is completed.

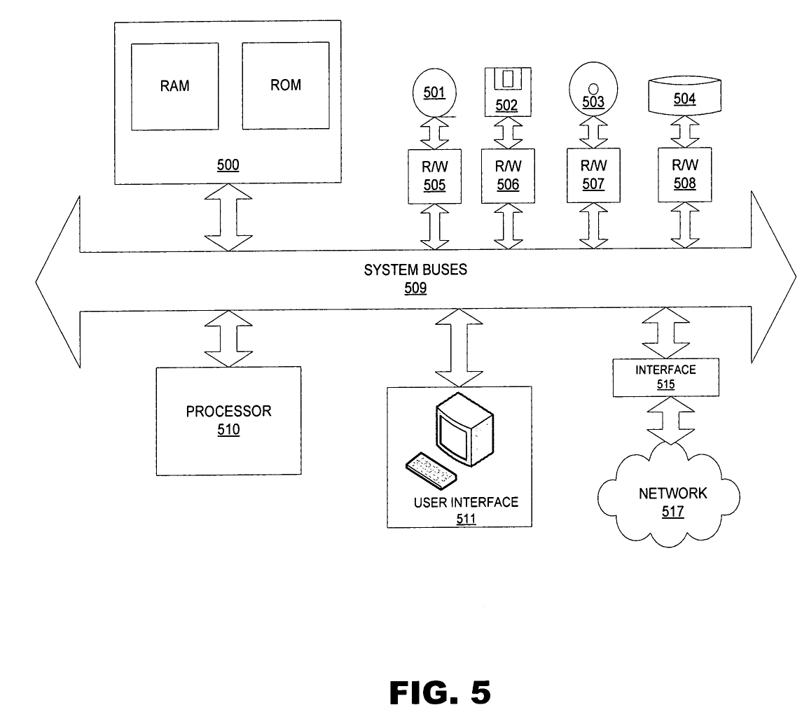

FIG. 5 shows a high-level representation of a computer system for implementing embodiments of the present invention, such as might be realized by a variety of known and commercially available hardware and software elements. The system may comprise a memory 500 including ROM and RAM, a processor 510 and a user interface 511 comprising a display device 512, a keyboard 513 and a mouse 514. Elements may communicate via system buses 509. The system may further comprise a network 517 connected by a network medium 518 and a network interface 515.

The embodiments of the invention described above may be implemented as computer-executable instructions and other data stored on machine-readable media such as magnetic tape 501, diskette 502, CD-ROM 503 and fixed disk 504. The computer-executable instructions may be retrieved from the machine-readable media 501-504 using their respective reading devices 505-508 into memory 500, and executed by a processor 510. The computer-executable instructions and other data may be distributed across a plurality of media, such as on physically separate storage devices respectively associated with physically separate computer systems that may communicate via a network. The functionality disclosed hereinabove may find specific implementations in a variety of forms, which are considered to be within the abilities of those of ordinary skill in the pertinent art after having reviewed the specification.

Several embodiments of the present invention are specifically illustrated and/or described herein. However, it will be appreciated that modifications and variations of the present invention are covered by the above teachings and within the purview of the appended claims without departing from the spirit and intended scope of the invention.

What is claimed is:

1. A method comprising:
based on an integration control operation to be performed, processing integration metadata comprising d information relating to integration to extract information corresponding to the integration control operation; and
using the extracted information, automatically generating a user interface to set up the integration control operation.

2. The method of claim 1, further comprising processing integration landscape definitions including connectivity information for systems to be integrated, to automatically generate the user interface.

3. The method of claim 1, wherein the integration control operation changes a behavior of an integration solution.

4. The method of claim 3, wherein the change in behavior includes changing at least one of message mappings, content or appearance of messages or portions of messages, and message properties.

5. The method of claim 1, wherein the user interface comprises a display having a format determined by the integration control operation to be performed.

6. A machine-readable medium storing computer-executable instructions to perform the method of claim 1.

7. A system comprising:
integration metadata comprising information relating to integration;
a processor; and
a storage medium to store computer-executable instructions executable by the computer processor to implement a generator, the generator to extract information corresponding to an integration control operation from the integration metadata and generate a corresponding user interface.

8. The system of claim 7, further comprising integration landscape definition data including connectivity information for systems to be integrated.

9. The system of claim 8, wherein the generator comprises logic to search for and extract information in the integration metadata and/or the integration landscape definition data relating to the integration control operation.

10. The system of claim 7, wherein the generator comprises logic to build background functionality of the user interface.

11. The system of claim 7, wherein the user interface comprises a display having a format determined by the integration control operation to be performed.

12. A method comprising:
applying an integration control operation definition to an integration database, the integration control operation to change at least one of message mappings, content or appearance of messages or portions of messages, and message properties, of a deployed integration solution;
extracting information from the integration database corresponding to the integration control operation; and
based on the extracted information, automatically generating a user interface to set up the integration control operation.

13. The method of claim 12, wherein the integration database comprises integration metadata developed while creating the integration solution, and integration landscape definitions including connectivity information for systems to be integrated.

14. The method of claim 12, wherein the user interface presents information extracted from the integration database, the information being alterable by a user to set up the integration control operation.

15. A machine-readable medium storing computer-executable instructions to perform the method of claim 12.
